(19) United States
(12) Patent Application Publication
(10) Pub. No.: US 2025/0021320 A1
(43) Pub. Date: Jan. 16, 2025

(54) COMPOSITE APPLICATION DEPLOYMENT

(71) Applicant: BRITISH TELECOMMUNICATIONS PUBLIC LIMITED COMPANY, London, Greater London (GB)

(72) Inventors: Andrew LORIMER, London (GB); Christopher WILSON, London (GB); Nigel WOOD, London (GB)

(21) Appl. No.: 18/713,439

(22) PCT Filed: Nov. 4, 2022
(86) PCT No.: PCT/EP2022/080847

§ 371 Date: May 24, 2024

(30) Foreign Application Priority Data
Nov. 25, 2021 (GB) 2116972.7

(51) Int. Cl. G06F 8/61

(52) U.S. Cl. CPC G06F 8/61

(57) ABSTRACT

A computer implemented method for deploying a composite software application including a plurality of software components, the method comprising: accessing a classifier trained to classify characteristics of one or more consuming entities to a class identifying a set of software components and a configuration for at least a subset of the identified components; generating the composite software application using a default set of software components each having a default configuration for deployment to a consumer of the generated software component; receiving characteristics for the consumer; determining a set of software components and a configuration for at least a subset of the determined components by executing the classifier based on the received characteristics; and adjusting the composite software application for deployment to the consumer based on the determined set of software components and configurations.

The present invention relates to the deployment of composite applications.

Composite software applications, such as applications that are streamed to users via a network, are composed of multiple components such as other software applications each having an individual configuration and being adapted to a particular use-case, scenario and/or purpose. A problem arises as the scenario and/or context of the application changes such that the application requires adjustment to a new state for suitability and efficacy in the new scenario/context.

It is therefore beneficial to provide for context-sensitive deployment of composite applications.

According to a first aspect of the present invention, there is provided a computer implemented method for deploying a composite software application including a plurality of software components, the method comprising: accessing a classifier trained to classify characteristics of one or more consuming entities to a class identifying a set of software components and a configuration for at least a subset of the identified components; generating the composite software application using a default set of software components each having a default configuration for deployment to a consumer of the generated software component; receiving characteristics for the consumer; determining a set of software components and a configuration for at least a subset of the determined components by executing the classifier based on the received characteristics; and adjusting the composite software application for deployment to the consumer based on the determined set of software components and configurations.

Preferably, the default set of software components is determined based on an characteristics of the consumer.

Preferably, the characteristics of the consumer comprises characteristics including one or more of: a temporal context; an environmental context; attributes of the consumer; a profile of the consumer; a set of software components in the software application; and a configuration of one or more of the software components in the software application.

According to a second aspect of the present invention, there is a provided a computer system including a processor and memory storing computer program code for performing the steps of the method set out above.

According to a third aspect of the present invention, there is a provided a computer system including a processor and memory storing computer program code for performing the steps of the method set out above.

Embodiments of the present invention will now be described, by way of example only, with reference to the accompanying drawings, in which:

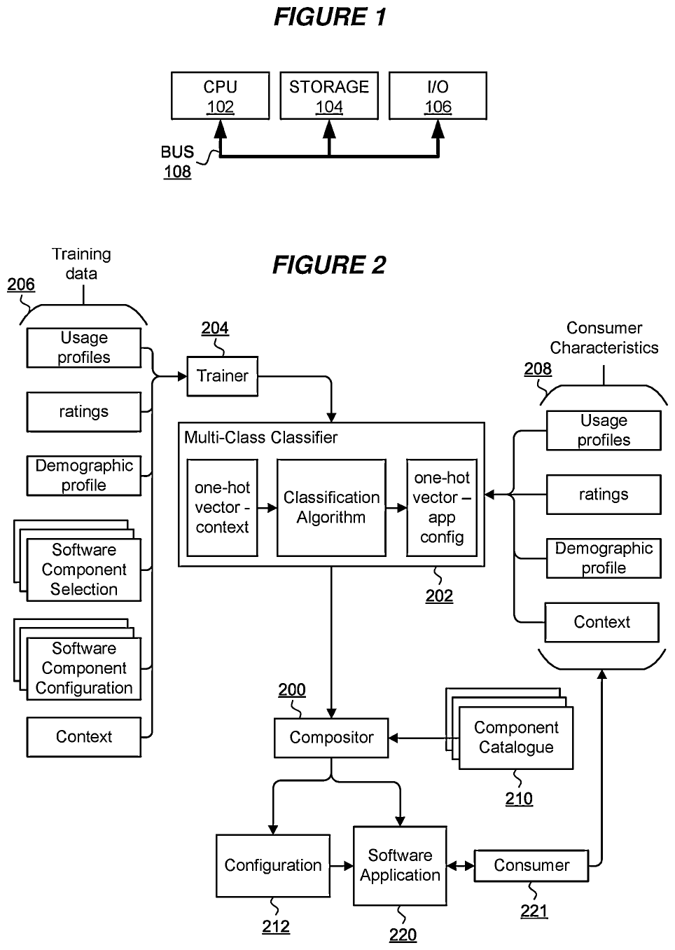

FIG. 1 is a block diagram a computer system suitable for the operation of implementations of the present invention;

FIG. 2 is a component diagram of an arrangement for deploying a composite software application;

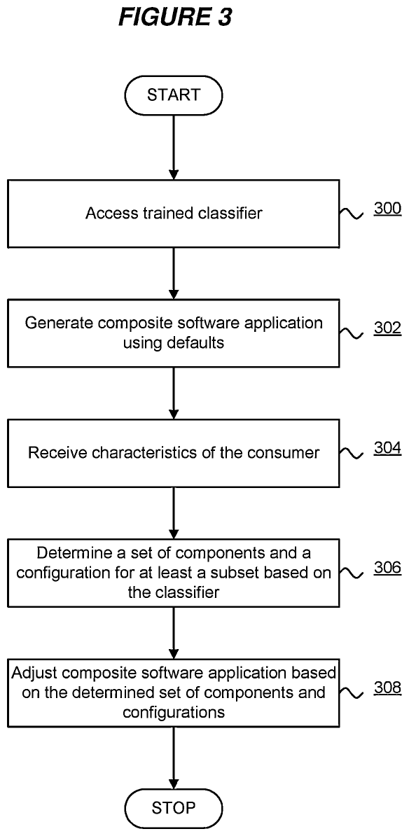

FIG. 3 is a flowchart of a method for deploying a composite software application.

FIG. 1 is a block diagram of a computer system suitable for the operation of embodiments of the present invention. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Embodiments of the present invention relate to the provision of a software application as a composite application comprising a plurality of one or more software components. For example, the composite application can be provided as a set of software components each having an interface for interaction therewith such as a programming, data or user interface, and being provided as a composite application for use by a consuming entity. The use of centralised and/or cloud-based software services can provide for the delivery of one or more interfaces to the composite application via a communications network, such as via the internet. For example, an interface to the software application may be communicated, accessed or streamed via a communications network such as to be rendered, accessible via or interacted through a client component by a consuming entity such as a local consumer client, a browser or the like.

Embodiments of the invention employ training data such as a one-hot vector encoding of characteristics of one or more consuming entities of a composite software application including characteristics of a context of the consumer. For example, the characteristics can include relative temporal information (such as a time, time period, duration or range of times), an indication or measure of efficacy of the deployed application (such as an indication or measure of effectiveness), usage and execution characteristics of the deployed application (such as frequency, duration or measure of extent of use of, or access to, the application or one or more components of the application), a selection of components constituted in the software application, and a configuration of one or more components in the application and/or of the application itself. The training data is used to train a classifier to classify consumer characteristics to a software component selection including, for at least some components, a configuration. For example, classification algorithms can be employed such as, inter alia: k-nearest neighbour; decision trees; naive bayes; random forest; and gradient boosting. Additionally or alternatively, the classifier can be constituted by multiple binary classification algorithms such that each binary classification algorithm is provided for each of a plurality of classes (constituted by a component selection and configuration) on a one-vs-rest or one-vs-one basis.

The training data can be constituted as a set of positive and (optionally) negative training examples according to which a selection of software components and a configuration of selected software components is constituted as an output class for an input of the classifier.

In use in operation, a compositor component is provided to compose a software application (e.g. stream) including a subset of software components from a component repository such as a catalogue. The compositor determines the selection of components and their configuration based on a classification by the classifier of run-time (production) data corresponding to a current context for the application. The collection of production context data for processing by the classifier and the composition of the application by the compositor occurs iteratively or responsive to one or more trigger conditions (such as a substantive or threshold change to the production data) so as to regenerate (or adjust/adapt) the software application responsive to changes in context. In this way, the software application is adapted as consumer characteristics change.

In one exemplary implementation, the software application is a stream of software functions from a software component catalogue and the context includes a state of one or more software functions such as a state determined based on data stored by, for or with the one or more software functions in conjunction with extrinsic contextual characteristics such as a time of day, time of year, physical or geographic conditions, and/or a profile of a consuming entity such as a user of the application. In such exemplary implementation, the stream of software functions is adapted by the compositor on the basis of a change to a classification of the context such that a user of the stream accesses adapted software functions responsive to context.

FIG. 2 is a component diagram of an arrangement for deploying a composite software application. A compositor 200 is provided as a hardware, software, firmware or combination component arranged to generate composite software application 220 as an application for which interfaces are provided to a consuming entity 221 such as a consuming software application, a consuming service, a user or the like. Use of the software application 220 by such consuming entity 221 is achieved via an interface associated with the composite application 220 such as a programming, data or user interface. For example, an applications programming interface (API) can be provided for the composite application 220 through which a consuming entity 221 such as a software component can interface with the application to use the application. Similarly, a user interface can be provided for the composite application 220 for use of the application 220 by a user consumer 221. The application can be provided to the consumer 221 through a communications network such as by streaming the application or an interface to the application via the communications network to the consumer 221.

The compositor 200 is operable to generate the composite software application 220 to comprise a plurality of individual software components such as components taken from a component repository, registry, or catalogue 210. Each of one or more software components constituted in the composite software application 220 can have associated a configuration 212 such as a definition of one or more options, parameters, settings, characteristics and the like. Similarly, the software application 220 as a whole can have associated a configuration 212, which may itself include one or more configurations of constituent software components. The compositor 200 is thus arranged to generate the composite software application 220 from components in the catalogue 210 including a configuration 212 for at least a subset of constituent components.

In use, the compositor 200 initially generates the composite software application 220 on the basis of a default set of software components each having a default configuration for deployment to the consumer 221. For example, the default set of software components and their configuration may be predetermined or may be selected on the basis of characteristics or, or associated with, the consumer 221 as will be described below.

Further, in use, the compositor 200 is operable to access a classifier 202 such as a multi-class classifier. The classifier 202 is a hardware, software, firmware or combination component employing a classification technique or algorithm to classify a set of input data to a classes as output data. Example classification algorithms include, inter alia: k-nearest neighbour; decision trees; naive bayes; random forest; and gradient boosting. A multi-class classifier can be constituted by multiple binary classification algorithms such that each binary classification algorithm is provided for each of a plurality of classes (constituted by a component selection and configuration) on a one-vs-rest or one-vs-one basis. In use, the classifier is trained to classify input data corresponding to, or representing, characteristics 208 of the consumer 221 to one or more classes identifying a set of software in the component catalogue 210 and a configuration for at least a subset of the identified components. Thus, in this way, the classifier provides a mechanism for identifying a set of software components and configurations for at least a subset of the components for composition by the compositor 200 as the composite software application 220 for the consumer 221.

The classifier 202 is trained by a trainer component 204 such as a hardware, software, firmware, or combination component adapted to access training data to train the classifier. Training data 206 includes a plurality of training examples each including a definition of characteristics for each of one or more consumers and an identification of a corresponding set of software components including configuration information for each consumer. Such training data 206 can be defined empirically through monitoring use, by such training consumers, of composite applications in which consumers may identify, operate with, or proactively select software components so as to identify components for the composite software application, such selection and/or use including, for some components, configuring the components either explicitly or implicitly, such as through the nature of the use of such components. The characteristics of a consumer included in the training data 206 can include context information, for example, inter alia: a usage profile for an application such as a relative temporal information (such as a time, time period, duration or range of times) of use of and/or interaction with a software component by a consumer; an indication or measure of efficacy of a composite application used by the software component, such as an indication or measure of effectiveness, utility, suitability or other indicators; usage and execution characteristics of the deployed application such as frequency, duration or one or more measures of an extent of use of, or access to, the application or one or more components of the application; a selection of components constituted in the software application; and a configuration of one or more components in the application and/or of the application itself. Characteristics can further include ratings such as indications by a consumer of a utility, efficacy, suitability or other characteristic of a composite software application or one or more components constituted therein. For example, such ratings can be an automatically generated quantitative measure of utility of an application, or a proactively indicated rating such as by a user of a composite application. Further, a demographic profile for a consumer for a training data item can be provided including characteristics of the consumer such as a type, nature or origin of the consumer. For example, characteristics of a consumer software component such as a purpose of the component. Similarly, characteristic of a consuming user such as characteristics of the user, their role, their function or an indication of their use case or one or more objectives.

One way that the potential richness of the training data 206 can be represented to the classifier 202 for training and representation purposes is by one-hot vector representation of the training data 206. For example, consumer characteristics for a training data item can be one-hot encoded for training the classifier 202 to a further one-hot encoding of a composite application definition and configuration. For example, backpropagation is a technique that can be employed to train a classifier employing such one-hot encodings for input and output data.

Thus, once trained, the classifier 202 is suitable for informing the compositor 200 of a constitution and configuration of a composite software application 220 as a class of output of the classifier 202 on the basis of an input to the classifier representing consumer characteristics 208 of the consumer 221. The consumer characteristics 208 constitute input characteristics for the classifier 202 including, for example, inter alia, usage profile, rating, demographic profile and contextual characteristics as previously described with respect to the training data 206. Thus, the trained classifier 202 classifies such input characteristics to an indication of software components for inclusion in a composite application 220 along with a configuration 212 for at least a subset of the components.

In use, the consumer characteristics are applied to the classifier such as iteratively or in response to a condition, or once per instantiation of the composite software application 220, so as to identify, by the compositor 200, a definition of a composite software application 220 such that a deployed composite software application 220 can be adjusted for deployment to the consumer 221 based on a set of software components and configurations determined by the classifier 202.

In one arrangement, the default set of software components and configurations are determined based on the characteristics 208 of the consumer 221, such as with reference to the trained classifier 202.

FIG. 3 is a flowchart of a method for deploying a composite software application. Initially at step 302 the method accesses a trained classifier 202 and at step 302 the method generates a composite software application 220 using a default set of software components each having a default configuration. At step 304 the method receives characteristics 208 of the consumer 221 and at step 306 the trained classifier 202 determines a set of components for constitution in the composite software application 220 including a configuration for at least a subset of the identified components. At step 308 the method adjusts the composite software application 220 based on the set of components and configurations determined at step 306.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for deploying a composite software application including a plurality of software components, the method comprising:
accessing a classifier trained to classify characteristics of one or more consuming entities to a class identifying a set of software components and a configuration for at least a subset of the identified components;
generating the composite software application using a default set of software components each having a default configuration for deployment to a consumer of the generated software component;
receiving characteristics for the consumer;
determining a set of software components and a configuration for at least a subset of the determined components by executing the classifier based on the received characteristics; and
adjusting the composite software application for deployment to the consumer based on the determined set of software components and configurations.

2. The method of claim 1 wherein the default set of software components is determined based on an characteristics of the consumer.

3. The method of claim 1 wherein the characteristics of the consumer comprises characteristics including one or more of: a temporal context; an environmental context; attributes of the consumer; a profile of the consumer; a set of software components in the software application; and a configuration of one or more of the software components in the software application.

4. A computer system including a processor and memory storing computer program code for performing the steps of the method of claim 1.

5. A computer program element comprising computer program code to, when loaded into a computer system and executed thereon, cause the computer to perform the steps of a method as claimed in claim 1.
